(19) United States
(12) Patent Application Publication
(10) Pub. No.: US 2008/0092974 A1
(43) Pub. Date: Apr. 24, 2008

(54) CONDUIT WITH SECURING FLAP

(75) Inventor: Michael Gleeson, El Paso, TX (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: M&Q Plastic Products, North Wales, PA (US)

(21) Appl. No.: 11/534,061

(22) Filed: Sep. 21, 2006

(51) Int. Cl. F16L 11/04; B22D 11/126

(52) U.S. Cl. 138/156; 29/527.1

(57) ABSTRACT

The present invention is directed to conduit or tubing for holding and/or protecting flexible members from exposure and/or contamination. The conduit preferably includes convolute tubing having a longitudinal slit and at least one securing flap for covering the slit to hold flexible members in the internal cavity of the tubing. The use of a flap in the slit conduit substantially prevents flexible members from undesired exit from the cavity of the conduit while at the same time protects the flexible members from exposure to the outside environment and contaminants. A method of manufacturing convolute tubing with a securing flap is also provided.

### TECHNOLOGY FIELD

This invention relates to conduit or tubing for holding flexible members and more particularly to convolute conduit or tubing for holding flexible electrical wires. This technology is particularly suited, but by no means limited, for use by the automotive industry as a protective covering for wiring assemblies in automobiles.

### BACKGROUND

Convolute conduit, also referred to as convolute tubing or split loom, is designed as a protective covering for flexible members. One common application is in the automotive industry where convolute conduit is used as a protective covering for wire harnesses. Convolute conduit has been in use for over fifty years in the automotive industry, where it is used, among other things, to protect enclosed wires against abrasion, dirt, oil, brake fluid, steering fluid and against elevated temperatures. Convolute conduit also serves to contain the wires in the harness after manufacture and assembly of the wire harness at one manufacturing facility and allows for easy shipment and assembly of the finished product in an automobile located at another manufacturing facility.

Conventional convolute tubing products typically have a longitudinal slit along a length of the product, which facilitates assembly of the convolute tubing around, for example, the electrical wires on an assembled electrical wiring harness. However, the slit in the assembled tubing may cause certain problems. For example, when the assembled harness is removed from the board and “hanked” (i.e., wrapped in a bundle) the tube is bent or twisted and the wires sometimes come out of the conduit through the slit or may be otherwise exposed via the slit. This condition is also likely to be evidenced when the harness is shipped to the auto assembly plant. This is not acceptable to the industry, so harness manufacturers typically wrap tape around the outside of the tubing to hold the slit closed and retain the wires within the tubing.

### SUMMARY

In view of the above shortcomings and drawbacks, devices, systems and methods for the mitigation of flexible members exiting or extruding from flexible conduit or tubing are provided. According to one embodiment of the present invention, the convolute conduit design is modified by extending a securing flap on one edge of the slit tube so that when the tube is closed, the flap will extend under the opposing side of the slit and will therefore close the slit and retain the flexible members contained therein, even when the tube is bent or twisted.

One of the benefits of a convolute conduit with a securing flap is that the flap substantially prevents flexible members, for example electrical wires, disposed within the tubing from exiting or extruding through the slit in the tubing. Furthermore, in one preferred embodiment of the present invention, an internal flap acts as a blocking or self-locking device when the flexible members contained inside the tubing press against the flap, for example. The self-locking may occur when flexible members contained in the internal cavity of the conduit press against the flap making the distal end of the flap contact the interior surface of the side wall opposite the side of the slit to which the proximal end of the flap is connected, resulting in substantial closure of the slit by the flap.

One preferred embodiment of this invention has a flexible flap that allows deflection of the flap for easy insertion of wires into the tubing (or insertion of the tubing on to flexible wires). Moreover, the use of a flap to close the slit eliminates the need for taping, reduces the cost of the harness covering, reduces the labor involved in assembly and gives overall better protection against intrusion from outside contamination. Additionally, a convolute conduit having a flap will provide aesthetic improvement to the look of the harness and will make recycling of the convolute tubing easier at the end of the conduit life because there will be no tape to remove in the recycling process.

The convolute tubing of this invention may include a body, an internal cavity defined within the body, a longitudinal slit along the longitudinal length of the body, and a flap connected to the body. The tube body may further include a first opening, a second opening, and a sidewall having a longitudinal length extending between and connecting the first opening and the second opening. The slit operatively couples the exterior of the body with the internal cavity of the body. The flap extends across and selectively closes the slit.

In one embodiment of the present invention, the convolute tubing may include a flap located on an interior surface of the tube body. The flap may itself include a proximal end connected along one side of the body proximate to the slit; a flexible arm extending transversely across the longitudinal slit; and a distal end that is positioned on an opposite side or edge of the slit.

According to one embodiment of this invention, the flexible arm of the flap of the convolute conduit may be deflectable into the internal cavity of the tube body. The inward deflection of the flap allows insertion of flexible members, for example electrical wires, from the exterior of the body into the internal cavity of the tube. Contact of the distal end of the flap with the interior surface of the tube body substantially prevents radially outward deflection of the flexible arm of the flap beyond the interior surface of the tube body. The flap may be an integral extension of the body proximate to the slit.

In yet another embodiment, the convolute tubing may include a flap located on an exterior surface of the body. The flap may further include a proximal end connected along one side of the body proximate to the slit; a flexible arm that extends transversely across the longitudinal slit; and a distal end that is positioned on an opposite side of the slit from the proximal end. The flexible arm of the flap may be deflectable radially outward and away from the tube body. The outward deflection of the flap may allow insertion of electrical wires from an exterior of the body into the internal cavity of the tube body.

In another embodiment, the convolute tubing may further include a first flap extending from a first side of the longitudinal slit generally traversely across the slit; and a second flap extending from a second side of the longitudinal slit generally traversely across the slit. The first flap and the second flap overlap and cover the slit. Moreover, the first flap and the second flap may each be deflectable into the internal cavity of the convolute tubing according to this embodiment.

The present invention also provides a method of manufacturing various embodiments of convolute conduit. One preferred method of manufacturing convolute conduit may include the steps of extruding a substantially cylindrical tube of plastically deformable polymeric material; forming a groove along a longitudinal length of the tube; cutting a slit in the tube along a plane of the groove; and curing the polymeric tube while the tube is in a final shape required. The groove may be formed on an external side of the tube, and the groove may partially expose a first longitudinal face and a second longitudinal face on the tube. When the groove is formed on the body of the tubing, a member may extend between the first longitudinal face and the second longitudinal face. The member may form a flap that extends from at least one of the first longitudinal face and/or the second longitudinal face of the tube. A method of manufacturing convolute tubing according to this invention may further include the steps of cutting a slit along a plane in a center region of the member to form a first flap extending from the first longitudinal face and a second flap extending from the second longitudinal face, and overlapping the first flap and the second flap during the curing step.

The final shape of the convolute conduit may have the flap extending across the slit a distance past the longitudinal face opposite to the longitudinal face from which the flap extends thereby covering the slit.

A method of manufacturing convolute tubing according to this invention may further include forming a plurality of convolutions on the cylindrical tube. Additionally, the curing step may further include cooling the tube from a temperature above the glass transition temperature of the polymeric material to room temperature.

A method of manufacturing convolute tubing according to this invention may further include forming the flap integral with one of the first longitudinal face and/or the second longitudinal face of the polymeric tubing by slitting the tube longitudinally proximate to the other of the first longitudinal face and/or the second longitudinal face.

This invention also provides a convolute tubing system having a securing flap that extends across and selectively closes a slit in the convolute tubing, and a wire harness contained within the internal cavity of the conduit body.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 shows a perspective view of a convolute conduit according to one embodiment of the invention;

FIG. 2 shows a side view of the convolute conduit of FIG. 1;

FIG. 3 shows an end view of the convolute conduit according to one embodiment of the invention;

FIGS. 4A and 4B show enlarged details of the flap of the convolute conduit according to preferred embodiments of this invention;

FIG. 5 shows an enlarged end view of the flap of the convolute conduit according to an alternate embodiment of the invention;

FIG. 6 shows an enlarged end view of the flaps of the convolute conduit according to yet another embodiment of this invention;

FIG. 7 shows an end view of the convolute conduit of this invention after an extrusion step according to one exemplary manufacturing process; and

FIG. 8 shows an end view of the convolute conduit after a cutting step in an exemplary manufacturing process.

### DETAILED DESCRIPTION OF ILLUSTRATIVE EMBODIMENTS

This invention provides a flexible conduit or tubing having a securing flap that provides an improved means of holding and protecting flexible members, such as, for example, electrical wiring assemblies in automobiles. The conduit having a securing flap provides a simple yet effective countermeasure to the problem of undesired exits and/or contamination of flexible members contained within conduit. Addition of a securing flap to cover a slit in the conduit results in substantial prevention of undesired exit and or exposure of flexible members contained in the conduit. A flap keeps the flexible members inside the conduit even in cases where the conduit is bent or twisted. Moreover, a flap also reduces and/or prevents the ingress of contaminants into the conduit. In one preferred embodiment, the conduit includes flexible convolute and/or extruded conduit. Addition of a securing flap to close the slit in the convolute tubing may be realized with minimal change to current methods of convolute conduit manufacture; thus, addition of a flap is not only a technically feasible alternative, but also a cost effective countermeasure to reduce or substantially prevent contamination and/or exit of flexible members contained in slit convolute conduit.

Convolute conduit having a securing flap covering the slit opening according to the present invention is particularly well suited for, but by no means limited to, use in the automotive industry, where it may be used to hold wire harnesses in the engine compartment. Convolute conduit having a securing flap covering the slit opening may have applicability in fields other than the automotive industry. For instance, slit convolute tubing having a securing flap may be used in the telecommunications industry to hold copper, hard wire, cable wires and fiber optic cables, for example. Other areas where convolute conduits of the type described herein may have applicability may be the in the electrical power distribution industry, information distribution industry (e.g., the Internet), construction industry (e.g., plumbing and insulation applications), and the like.

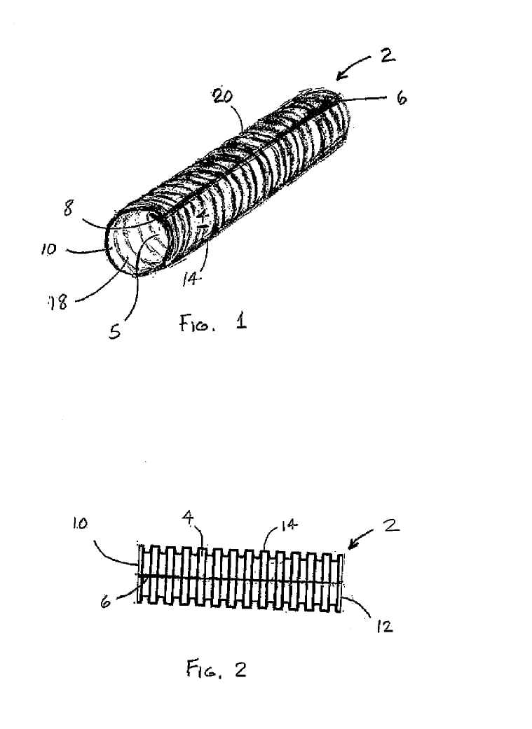

FIG. 1 and FIG. 2 show a diagrammatic representation of tubing 2, which as shown includes convolute tubing or conduit. As shown, convolute tubing 2 may include a body 4, an internal cavity 5 defined within the body 4, a longitudinal slit 6 formed along the longitudinal length of body 4, and a flap 8 that extends across and selectively closes slit 6. The body 4 further comprises a first opening 10, a second opening 12, and a sidewall 14 having a longitudinal length extending between and connecting the first opening 10 and the second opening 12. The slit 6 operatively couples the exterior of body 4 with the internal cavity 5. As shown, the tubing 2 may include a series of annular convolutions (i.e., ridges and valleys) that add strength and rigidity to the tubing, while also maintaining flexibility.

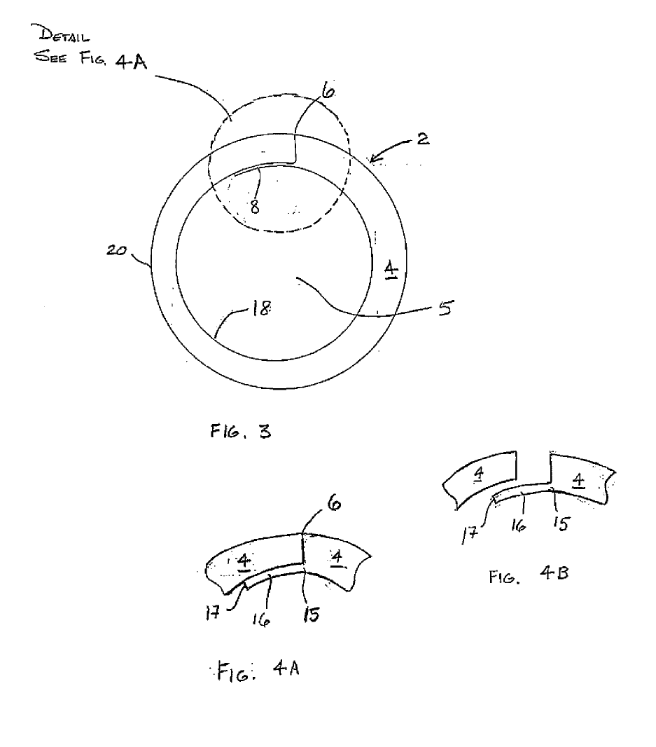

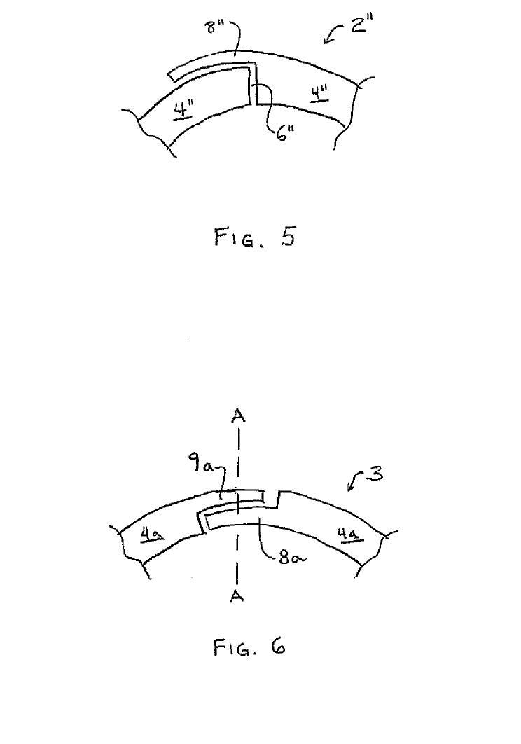

As shown in FIG. 3, FIG. 4A, and FIG. 4B, flap 8 may be located on the interior surface 18 of body 4. As shown, flap 8 may include a proximal end 15, a flexible arm 16, and a distal end 17. Proximal end 15 is connected along one side of body 4 proximate to slit 6. Flexible arm 16 extends transversely across longitudinal slit 6. Distal end 17 is positioned on an opposite side of slit 6 from proximal end 15. Flap 8 may be an integral extension of body 4 proximate to slit 6, or alternatively, may be formed as a separate piece that is affixed to one side of slit 6.

In one embodiment of the present invention as depicted in FIG. 3, FIG. 4A and FIG. 4B, flexible arm 16 is deflectable into internal cavity 5. Inward deflection of flap 8 of convolute tubing 2 allows insertion of, for example, electrical wires from the exterior of body 4 into internal cavity 5. Contact of distal end 17 of flap 8 with interior surface 18 of tube body 4 reduces and/or substantially prevents radially outward deflection of flexible arm 16 of flap 8 beyond interior surface 18 of tube body 4. As shown in FIG. 4B, the effectiveness of the present invention to hold flexible members is not limited to cases where the entire flexible arm 16 is inside interior surface 18. Radial outward deflection of flap 8 is substantially prevented when distal end 17 of flap 8 is generally inside the interior surface 18 of tube body 4.

FIG. 5 shows yet another embodiment of convolute tubing 2″ wherein flap 8″ is positioned on the exterior surface of tube body 4″. As shown, flap 8″ is deflectable outward and away from body 4″. The flap may be designed and constructed to allow outward deflection of the flap for insertion of flexible members from an exterior of the body 4″ into the internal cavity 5. The flap 8″ acts as a blocking mechanism to maintain closure of said slit 6″ devoid of additional mechanical locking structure.

FIG. 6 shows yet another embodiment of the present invention, wherein convolute tubing 3 comprises two overlapping flaps, namely, flap 8a and flap 9a extending circumferentially from tube body 4a. As shown, flap 8a extends generally traversely across line A-A, and flap 9a extends generally traversely across line A-A such that the two flaps 8a and 9a overlap.

An exemplary method of manufacturing a convolute conduit 2 includes the steps of extruding a substantially cylindrical tube 2 of plastically deformable polymeric material; forming a groove 25 along the longitudinal length of tube 2; cutting a slit 27 in tube 2 along the plane of a first longitudinal face 22; forming a flap 8, which extends from a second longitudinal face 24 of tube 2; and curing tube 2 while it is in a final shape required. In one preferred embodiment, groove 25 may be formed on the external side of tube 2 and partially exposes first longitudinal face 22 and second longitudinal face 24. The polymeric material may include, for example, nylon 6, polyethylene, polypropylene, fire retardant polyethylene, polyester, and the like.

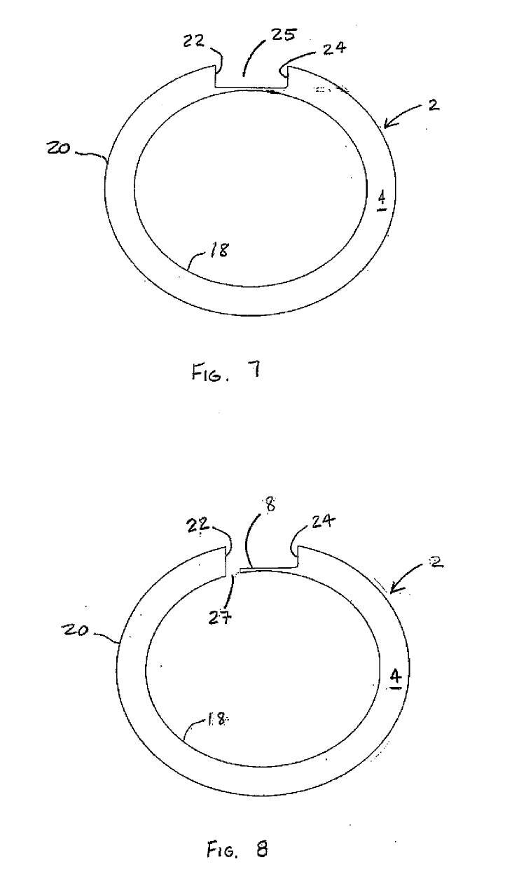

Representative intermediate steps in the manufacturing process of convolute conduit 2 are depicted diagrammatically in FIG. 7 and FIG. 8, which show end views of convolute tubing 2. During the intermediate step shown in FIG. 7, convolute conduit 2 comprises a member extending between first longitudinal face 22 and second longitudinal face 24. “First longitudinal face” should be understood to mean generally the face along which slit 27 is cut and “second longitudinal face” should be understood to mean generally the face from which slit 8 extends. The member extending between first longitudinal face 22 and second longitudinal face 24 may be formed using a modified mold having a solid structure that forms groove 25, as shown in FIG. 7. As shown on FIG. 8, the manufacturing process includes cutting the groove member along one edge to from slit 6, which operatively couples the exterior of convolute conduit 2 with the internal cavity 5.

According to one embodiment of the present invention, convolute conduit 2 may be cured in a final shape, as shown substantially in FIG. 3. In this illustrated embodiment, flap 8 extends generally circumferentially inside the internal circumference of tube 2 across slit 6 a distance past the first longitudinal face 22 opposite to the second longitudinal face 24 from which flap 8 extends. The curing step in the manufacturing process of convolute conduit 2 may comprise a step of placing tube 2 in, for example, a mold or vise-type device that constricts tube 2 in the desired final shape; and allowing tube 2 to cool from a temperature above the glass transition temperature of the polymeric material of tube 2 to room temperature.

The method of manufacturing convolute conduit 2 may further comprise a step of forming a plurality of convolutions on cylindrical tube 2. These convolutions may be both on the internal surface 18 as well as on the external surface 20 of convolute conduit 2, on the external surface only, and/or on the internal surface only.

The conduit with a securing flap preferably includes a design and construction that is inexpensive, easy to manufacture, easy to install over electrical wiring, facilitates shipment and storage of wiring systems protected by conduit having a securing flap, etc. The design and construction preferably minimizes that impact on the manufacturing process and does not include additional structure/features to reduce or substantially prevent the exit of wiring from the internal cavity of the conduit. Preferably, the securing flap acts as a blocking device to reduce and/or substantially prevent egress of wiring from the internal cavity of the conduit. Further, a conduit having an integral securing flap in accordance with the various embodiments of the present invention may act as a blocking or self-locking device when the flexible members contained inside the tubing press against the flap covering the slit in the conduit. This design and construction eliminates the need for any separate and additional structure to act as a locking mechanism to maintain the wiring within the conduit. Further, the use of a flap to close the slit eliminates the need for taping, reduces the cost of the harness covering, reduces the labor involved in assembly, gives overall better protection against intrusion from outside contamination, and improves the overall appearance of the conduit.

While systems and methods have been described and illustrated with reference to specific embodiments, those skilled in the art will recognize that modifications and variations may be made without departing from the principles described above and set forth in the following claims. Accordingly, reference should be made to the following claims as describing the scope of the disclosed embodiments.

What is claimed:

1. Convolute tubing comprising:
a body comprising a first opening, a second opening, and a sidewall having a longitudinal length extending between and connecting said first opening and said second opening;
an internal cavity defined within said body;
a longitudinal slit in said body formed along said longitudinal length, wherein said slit operatively couples an exterior of said body with said internal cavity; and
a flap connected to said body, wherein said flap extends across and selectively closes said slit.

2. The convolute tubing of claim 1, wherein said flap further comprises:
a proximal end connected along one side of said body proximate said slit;
a flexible arm that extends transversely across said longitudinal slit; and
a distal end that is positioned on an opposite side of said slit from said proximal end.

3. The convolute tubing of claim 1, wherein said flap is located on an interior surface of said body, and wherein said flap is deflectable into said internal cavity.

4. The convolute tubing in accordance with claim 3, wherein said inward deflection of said flap allows insertion of flexible members from an exterior of said body into said internal cavity.

5. The convolute tubing in accordance with claim 3, wherein contact of a distal end of said flap with said interior surface of said tube body substantially prevents radially outward deflection of said flap beyond said interior surface of said body.

6. The convolute tubing in accordance with claim 5, wherein said contact of said flap with said interior surface of said tube body act as a self locking mechanism devoid of additional structure to maintain closure of said slit.

7. The convolute tubing in accordance with claim 1, wherein said flap is an integral extension of said body.

8. The convolute tubing of claim 1, wherein said flap is located on an exterior surface of said body, wherein said flap is deflectable outward and away from said body.

9. The convolute tubing in accordance with claim 8, wherein said outward deflection of said flap allows insertion of flexible members from an exterior of said body into said internal cavity.

10. The convolute tubing in accordance with claim 8, wherein said flap acts as a blocking mechanism to maintain closure of said slit devoid of additional mechanical locking structure.

11. The convolute tubing in accordance with claim 1, further comprising:
a first flap extending from a first side of said longitudinal slit traversely across said slit; and
a second flap extending from a second side of said longitudinal slit traversely across said slit;
wherein said first flap and said second flap overlap and cover said slit.

12. The convolute tubing in accordance with claim 11, wherein said first flap and said second flap are deflectable into said internal cavity.

13. A method of manufacturing a convolute conduit comprising:
extruding a generally cylindrical tube of plastically deformable polymeric material;
forming a groove along a longitudinal length of said tube, said groove formed on an external side of said tube, said groove partially exposing a first longitudinal face and a second longitudinal face and comprising a member extending between said first longitudinal face and said second longitudinal face;
cutting a slit in said tube along a plane of said groove, wherein said member forms a flap extending from at least one of said first longitudinal face and said second longitudinal face of said tube; and
curing said polymeric tube while said tube is in a final shape required, wherein said final shape has said flap extending across said slit and a distance past said longitudinal face opposite to the longitudinal face from which the flap extends thereby covering said slit.

14. The method in accordance with claim 13, wherein the method further comprises forming a plurality of convolutions on said cylindrical tube.

15. The method in accordance with claim 13, wherein said curing further comprises cooling said tube from a temperature above the glass transition temperature of said polymeric material to room temperature.

16. The method in accordance with claim 13, further comprising forming said flap integral with one of said first longitudinal face and/or said second longitudinal face of said polymeric tubing by slitting said tube longitudinally proximate the other of said first longitudinal face and/or said second longitudinal face.

17. The method in accordance with claim 13, further comprising cutting said slit along a plane of one of said first longitudinal face and said second longitudinal face.

18. The method in accordance with claim 13, further comprising extending said flap circumferentially inside an internal circumference of said tube.

19. The method in accordance with claim 13, further comprising:
cutting said slit along a plane in a center region of said member to form a first flap extending from said first longitudinal face and a second flap extending from said second longitudinal face; and
overlapping said first flap and said second flap during said curing step.

20. A convolute tubing system for securely holding flexible members within said convolute tubing, said convolute tubing system comprising:
a body comprising a first opening, a second opening, and a sidewall having a longitudinal length extending between and connecting said first opening and said second opening;
an internal cavity defined within said body;
a longitudinal slit in said body formed along said longitudinal length, wherein said slit operatively couples an exterior of said body with said internal cavity;
a flap connected to said body, wherein said flap extends across and selectively closes said slit, wherein said flap further comprises:
a proximal end along one longitudinal edge of said slit;
a flexible arm that extends transversely across said slit;
a distal end that is located beyond an opposite longitudinal edge of said slit; and
wherein said flap is flexible and deflects to allow flexible members to pass through said longitudinal slit and into said internal cavity, and wherein said flap substantially prevents exit of said flexible members from said internal cavity through said longitudinal slit.
